(19) United States
(12) Patent Application Publication
(10) Pub. No.: US 2023/0311176 A1
(43) Pub. Date: Oct. 5, 2023

(54) Medical Waste Treatment System and Method

(71) Applicant: Radom Corporation, Sunrise, FL (US)

(72) Inventors: Jovan Jevtic, West Allis, WI (US); Qi Rao, Pewaukee, WI (US); Roman Bensen, Delray Beach, FL (US)

(73) Assignee: Radom Corporation, Sunrise, FL (US)

(21) Appl. No.: 17/710,908

(22) Filed: Mar. 31, 2022

(51) Int. Cl. B09B 3/00; C10J 3/20; C10J 3/18

(52) U.S. Cl. CPC B09B 3/00; C10J 3/20; C10J 3/18; C10J 2300/1215; C10J 2300/1618; C10J 2300/165; C10J 2300/0946

(57) ABSTRACT

A medical zero emission waste system comprising a medical waste treatment unit that couples to a medical facility. The medical waste treatment unit is onsite to the medical facility for processing medical waste generated by the medical facility. The medical waste treatment unit comprises a gasification reactor, a syngas treatment unit, and a synthetic fuel generator for treating and converting medical waste. The synthetic fuel generator comprises an electrolysis unit and a liquid fuel synthesis unit. The medical waste treatment unit converts the medical waste to synthetic fuel, gaseous fuel, oxygen, heat, slag, and other components that are useful to the medical facility or other entities. The medical waste treatment system uses carbon dioxide generated during a medical waste conversion process thereby producing substantially zero emissions and eliminating medical waste that could be harmful to the environment.

### FIELD

The present invention relates to medical waste disposal and more particularly to a medical on-site or a mobile medical waste disposal system that generates substantially zero emissions during a disposal of medical waste local to a medical facility.

### BACKGROUND

Waste management for a medical facility is a complex process depending on the medical waste being disposed of. The medical waste has to be collected at the facility, transported away from the facility, and disposed of in a manner suitable for the type of medical waste. Moreover, medical waste is regulated. Typically, medical waste requires special handling and proper tracking to ensure correct disposal. Medical waste collection in a medical facility can consume many man hours of time especially if the medical waste is separated into recyclable waste, disposable waste, and hazardous or biological waste. Transportation and handling of medical waste from the medical facility expends energy and manpower at a cost to the environment. Medical waste disposal sites are often far from the general population within a given area thereby making transportation costs significant. Finally, the disposal of medical waste when brought to a remote location has to be disposed of separate from standard waste that introduces additional costs. In the case of toxic or hazardous materials the medical waste has to be handled and disposed of in a regulated manner. A large waste facility may have to manage the disposal of different toxic or hazardous materials at potentially large capital and human costs. This can be problematic if the medical waste is only a small portion of the waste that is being managed. Moreover, if many different entities handle the medical waste material there is a higher probability of error that can be detrimental to the environment or humans exposed to the medical waste. Thus, the medical waste disposal process can be inefficient, consume many different resources, and be harmful to the environment.

### BRIEF DESCRIPTION OF THE DRAWINGS

Various features of the system are set forth with particularity in the appended claims. The embodiments herein, can be understood by reference to the following description, taken in conjunction with the accompanying drawings, in which:

FIG. 1 is a block diagram of a zero emission waste system in accordance with an example embodiment;

FIG. 2 is a block diagram of the waste treatment unit of FIG. 1 in accordance with an example embodiment;

FIG. 3 is a block diagram of the gasification reactor of FIG. 2 in accordance with an example embodiment;

FIG. 4 is a block diagram of the syngas treatment unit of FIG. 2 in accordance with an example embodiment;

FIG. 5 is a block diagram of the synthetic fuel generator of FIG. 2 in accordance with an example embodiment;

FIG. 6 is a block diagram of the gasification reactor of FIG. 2 in accordance with an example embodiment;

FIG. 7 is a block diagram of the syngas treatment unit of FIG. 2 in accordance with an example embodiment;

FIG. 8 is a block diagram of the syngas treatment unit of FIG. 2 in accordance with an example embodiment;

FIG. 9 is a block diagram of the liquid fuel synthesis unit of FIG. 5 in accordance with an example embodiment; and

FIG. 10 is a block diagram of z zero emission waste system configured for treatment of medical waste in accordance with an example embodiment.

### DETAILED DESCRIPTION

The following description of embodiment(s) is merely illustrative in nature and is in no way intended to limit the invention, its application, or uses.

For simplicity and clarity of the illustration(s), elements in the figures are not necessarily to scale, are only schematic, are non-limiting, and the same reference numbers in different figures denote the same elements, unless stated otherwise. Additionally, descriptions and details of well-known steps and elements are omitted for simplicity of the description. Notice that once an item is defined in one figure, it may not be discussed or further defined in the following figures.

The terms “first”, “second”, “third” and the like in the Claims or/and in the Detailed Description are used for distinguishing between similar elements and not necessarily for describing a sequence, either temporally, spatially, in ranking or in any other manner. It is to be understood that the terms so used are interchangeable under appropriate circumstances and that the embodiments described herein are capable of operation in other sequences than described or illustrated herein.

Processes, techniques, apparatus, and materials as known by one of ordinary skill in the art may not be discussed in detail but are intended to be part of the enabling description where appropriate.

While the specification concludes with claims defining the features of the invention that are regarded as novel, it is believed that the invention will be better understood from a consideration of the following description in conjunction with the drawing figures, in which like reference numerals are carried forward.

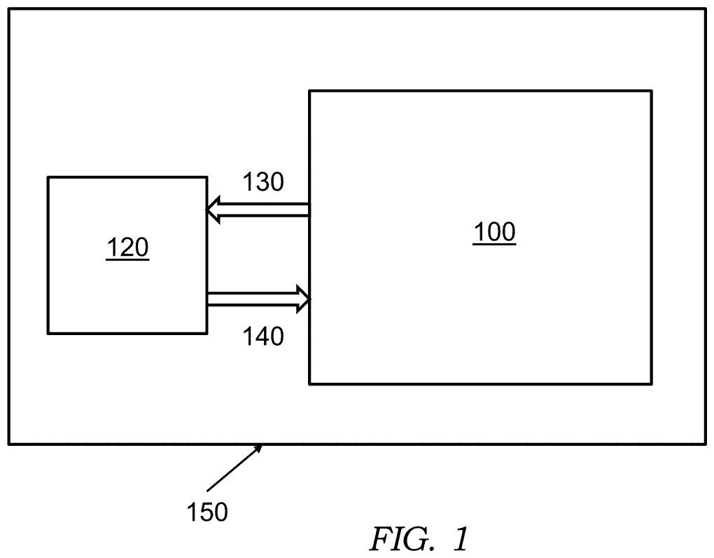

FIG. 1 is an illustration of zero emission waste system 150 in accordance with an example embodiment. Zero emission waste system 150 comprises facility 100 and waste treatment unit 120. Facility 100 produces waste 130 that is treated by waste treatment facility 120 to produce by-products 140 by way of a waste treatment process. Waste treatment unit 120 is within facility 100, a mobile waste treatment unit that couples to facility 100, or onsite to eliminate the need of waste transport, extra waste processing, or disposal at a different location. Waste treatment facility 120 uses one or more processes to treat waste 130 such that the waste treatment process produces substantially zero emissions to the environment. Thus, zero emission waste system 150 is a green system that protects the environment and reduces the need of landfills and other waste disposal schemes that introduce their own set of environmental problems. In addition, the carbon dioxide emissions that are produced by the waste treatment process are recycled to waste treatment unit 120 with appropriate chemical and physical processing such that the net carbon dioxide emissions of zero emission waste system 150 is zero or substantially zero. Moreover, the need to remove waste from facility 100 is completely eliminated. In one embodiment, facility 100 can be a building or area having 25 or more people that generate waste that may be biological, industrial, general garbage, or other type's wastes. In one embodiment, waste treatment unit 120 treats waste 130 produced by facility 100 and generates outputs that can be used by facility 100, waste treatment unit 120 or rendered to a form that is suitable for other applications that have value or are not environmentally detrimental. In one embodiment, the outputs of waste treatment unit 120 comprise liquid fuel, gaseous fuel, oxygen, heat, energy generation, water, steam, or inorganic byproducts. In addition, the gaseous products may be captured or converted such that facility 100 produces substantially zero gaseous emissions.

In general, zero emission waste system 150 is an onsite system that can process waste 130 generated by facility 100. In one embodiment, waste treatment unit 120 can be within facility 100 to support efficient transfer of waste 130. In one embodiment, waste treatment unit 120 can be on the grounds of facility 100. In one embodiment, waste treatment unit 120 can be a mobile unit that is configured to couple to facility 100 as needed. Thus, waste products 130 are eliminated onsite without special preparation for transport due to the type of waste being treated. Elimination of special waste preparation, the cost of transportation, and the cost of disposal of the waste are saved by waste treatment unit 120. In one embodiment, at least two of by-products 140 which are outputs of waste treatment unit 102 can be reused within facility 100 to lower operating expenses. Alternatively, by-products 140 are put in a form where it can be sold for use instead of requiring disposal. Zero emission waste system 150 produces substantially zero emissions that can harm the environment which benefits the people within facility 100 as well as the area in which facility 100 is located.

Waste 130 that is produced in facility 100 may be generated in any congregation of human population that is concentrated in an area that has easy access to waste treatment unit 120. Examples of facility 100 comprises a factory, an industrial complex, a school, a government building, a ship, a train, an airplane, a hospital, health care center, treatment clinic, physicians' offices, surgery center, out-patient treatment center, dental practices, a condominium complex, an apartment complex, a residential community, a retirement community, a gated community and facilities with 25 or more people where waste is produced in bulk or aggregated for treatment within a self-contained facility.

Facility 100 can be such that it produces waste 130 that are organic, inorganic, natural, artificial, metallic, non-metallic and combination of these materials. Waste 130 that is produced or generated in facility 100 may be benign, harmful, or toxic and therefore may require various methods for treatment or processing to render it harmless and also, if possible, reduce exposure of other living creatures to harmful effects and also exposure to the environment in terms of contamination of air, water, and the ground by emissions that can be gaseous, liquid, particulates, vapor as well as solid.

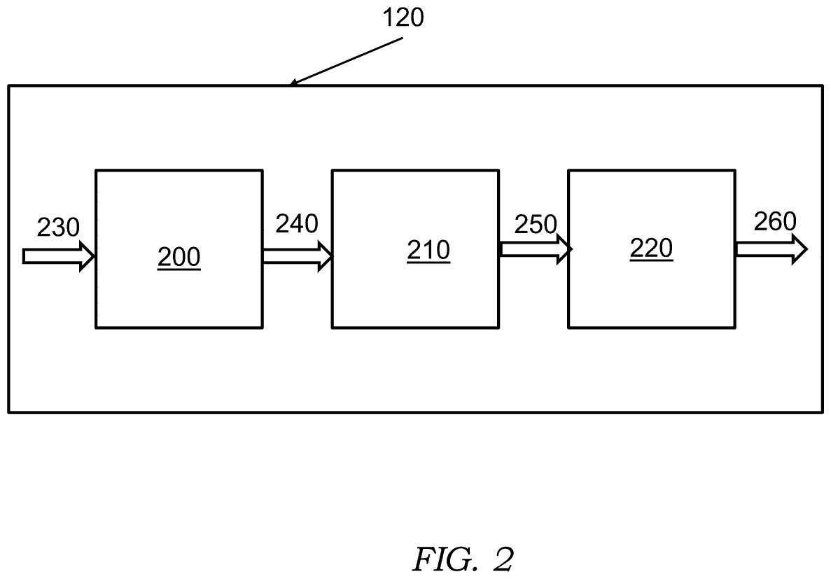

FIG. 2 is a block diagram of waste treatment unit 120 of FIG. 1 in accordance with an example embodiment. Waste treatment unit 120 comprises a gasification reactor 200, a syngas treatment unit 210, and a synthetic fuel generator 220. In one embodiment, waste treatment unit 120 receives waste generated by facility 100 of FIG. 1 including carbon dioxide emissions. Waste treatment unit 120, treats waste using specific chemical and physical processes and produces outputs that can be utilized by facility 100 while producing zero emissions of carbon dioxide, ensuring a net zero emission reuse cycle for carbon dioxide associated with waste treatment unit 120.

As shown in FIG. 1 waste 130 from facility 100 is provided to waste treatment unit 120. In one embodiment, waste 130 of FIG. 1 and one or more outputs of waste treatment unit 120 are provided to gasification reactor 200 as input 230. In the process of the treatment of waste 130 and recycled emissions, one output of the gasification process is synthesis gas or syngas. Syngas typically comprises carbon monoxide (CO), hydrogen (H₂) and carbon dioxide (CO₂) which also contains most of the original energy of the gasified waste. Raw syngas 240 produced by gasification reactor 200 is provided to gas treatment unit 210. Gasification reactor 200 can produce other outputs besides raw syngas 240 which will be discussed in detail herein below. Particulates or other gases generated during the production of raw syngas 240 are removed by syngas treatment unit 210. Syngas treatment unit 210 outputs clean syngas 250 that is then provided to synthetic fuel generator 220. Synthetic fuel generator 220 processes clean syngas 250 to undergo chemical and physical reactions that produce output 260. In one embodiment, output 260 from synthetic fuel generator 220 can be used or recycled by facility 100 or waste treatment unit 120 of FIG. 1 to eliminate emissions or power one or more devices to reduce energy consumption. In one embodiment, output 260 from synthetic fuel generator 220 can comprise a synthetic fuel which can be liquid or gaseous. In addition, an output of synthetic fuel generator 220 can comprise carbon dioxide which is recycled and fed back to waste treatment unit 120 which will be shown in detail herein below. In one embodiment, synthetic fuel generator 220 produces thermal energy as heat that is used to reduce emissions to the environment, generate energy, or heat facility 100 of FIG. 1.

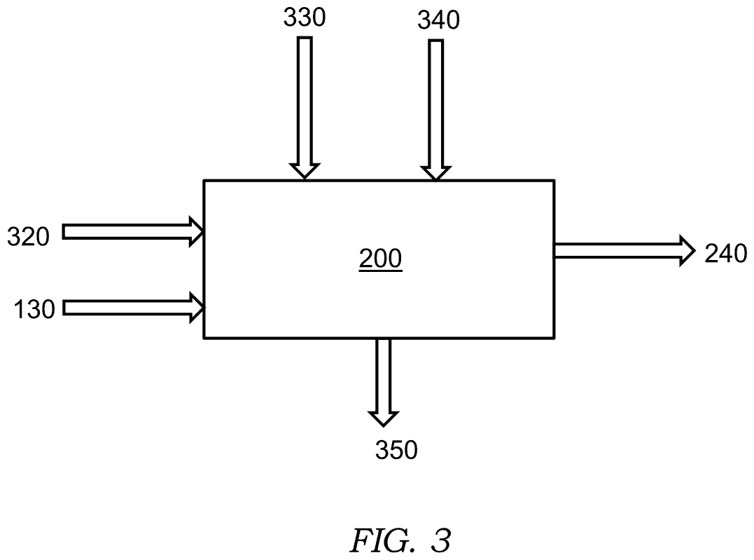

FIG. 3 is a block diagram of gasification reactor 200 of FIG. 2 in accordance with an example embodiment. Gasification reactor 200 is a component of waste treatment unit 120 of FIG. 2. Input 230 to gasification reactor 200 is described in more detail in FIG. 3 and comprises two or more different inputs. Gasification reactor 200 has an input of waste 130 from facility 100 of FIG. 1. Furthermore, gasification reactor 200 has an input 340 for receiving carbon dioxide, an input for receiving steam 320, and an input 330 for receiving electrical energy. The carbon dioxide coupled to input 340 can be from factor 100 or waste treatment unit 120 of FIG. 2. In one embodiment, gasification reactor 200 uses electrical energy to power one or more plasma torches to convert steam into steam plasma. The steam plasma creates a dense high energy plasma that results in the gasification of the introduced waste with high efficiency. The dense high energy plasma is also at a high temperature such as 800-1100° C. Adding carbon dioxide to the gasified waste within gasification reactor 200 produces raw syngas 240. In one embodiment, carbon dioxide is generated as a by-product within another block of waste treatment unit 120 of FIG. 2 and used in this process to maintain substantially zero emissions. In one embodiment, synthetic fuel generator 220 of FIG. 2 generates carbon dioxide which is a source provided to input 340. Raw syngas 240 comprises carbon monoxide (CO), hydrogen (H₂) and carbon dioxide (CO₂). In addition to raw syngas 240 that is produced by the dense high energy plasma, other toxic gases are reduced by the dense high energy plasma to its component molecules, which can be organic or inorganic. The inorganic molecules produced by a plasma treatment of waste 130 results in a slag 350 or solid waste that is removed or output from gasification reactor 200. Slag 350 can consist of a combination of vitrified ash and elemental metals that are melted from the plasma treatment of waste 130. The vitrified ash of slag 350 can be safely disposed of or used as construction material, depending on the composition. The metals from slag 350 that are recovered from gasification reactor 200 may be recycled by further physical and chemical treatment. The electrical energy provided to input 330 used in gasification reactor 200 may be supplied from an external source using various generation systems or may be generated locally in zero emission waste system 150 by using a portion of the fuel that is synthesized by synthetic fuel generator 220 of FIG. 2. Alternatively, a green source such as solar cells or wind power could be used to provide the electrical energy to input 330. Steam provided to input 320 is used for producing the steam plasma may be supplied from an external source using various steam generating systems or it may be produced locally by facility 100 or waste treatment unit 120. For example, fuel generated by waste treatment unit 120 can be used as an energy source to power a steam generator to produce steam used in gasification reactor 200.

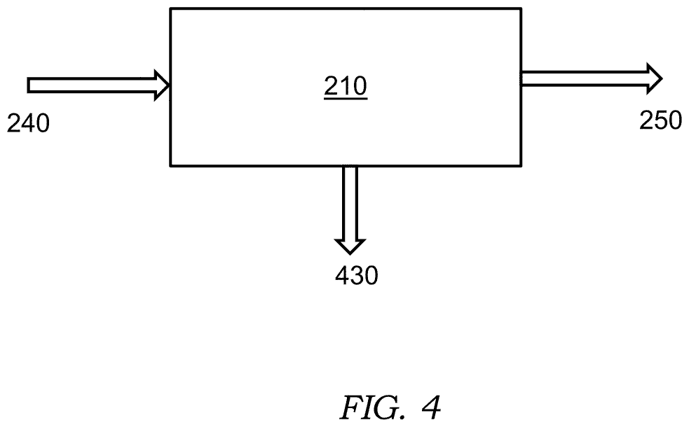

FIG. 4 is a block diagram of syngas treatment unit 210 in accordance with an example embodiment. Raw syngas 240 from gasification reactor 200 of FIG. 3 is coupled to syngas treatment unit 210. Raw syngas 240 contains gases as well as particulates and is exhausted at high temperature from syngas treatment unit 210. Raw syngas 240 requires treatment with chemical and physical processes before it can be used further. Syngas treatment unit 210 takes raw syngas 240 at high temperature and treats it with physical and chemical processes such as cooling, compression, and gas ratio adjustment to produce clean syngas 250. For example, syngas treatment unit 210 removes toxic gases 430 such as sulfur and chlorine during treatment of raw syngas 240 to produce clean syngas 250. In one embodiment, syngas treatment unit 210 treats raw syngas 240 with an exhaust heat boiler for thermal energy exchange to reduce the temperature. In one embodiment, recovered heat from the cooling of raw syngas 240 may be used to superheat the steam in the plasma torch of gasification reactor 200, thereby reducing the electrical energy required for the process of generating and operating the plasma torch therein. In one embodiment, raw syngas 240 after being cooled is coupled to a particulate filter to remove particulates of various sizes. Examples of a filtration system used to remove the particulates from raw syngas 240 are a cyclone filter, a bag filter, or an electrostatic filter or a combination of different filtration mechanisms to reduce the particulate density to the desired concentration in raw syngas 240. In one embodiment, a caustic scrubber is used in syngas treatment unit 210 to remove the toxic gases such as sulfur and chlorine from raw syngas 240. Other gas scrubbing mechanisms may also be used to remove the sulfur and chlorine, as will be evident to those well skilled in the art. The desulfurization of raw syngas 240 is required because sulfur containing impurities can poison metallic catalysts that may be used downstream in a synthetic liquid process. The sulfur and chlorine may be disposed or used as feedstock in other chemical processes. In general, raw syngas 240 is treated in syngas treatment unit 210 to produce clean syngas 250 that is cooled and suitable for synthetic fuel generation using suitable physical and chemical processes.

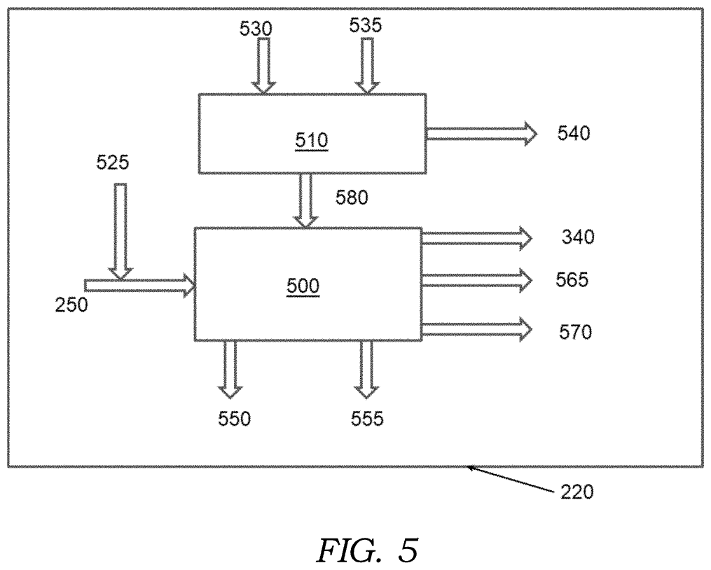

FIG. 5 is a block diagram of synthetic fuel generator 220 of FIG. 2 in accordance with an example embodiment. Synthetic fuel generator 220 is a component of waste treatment unit 120 of FIG. 2 and is configured to receive clean syngas 250 from gasification reactor 200 of FIG. 3. Synthetic fuel generator 220 comprises a liquid fuel synthesis unit 500 and an electrolysis unit 510. In one embodiment, liquid fuel synthesis unit 500 has a Fischer Tropsch reaction chamber that synthesizes clean syngas 250 into synthetic liquid fuel 565 and gaseous fuel 570 using specific physical and chemical processes. In addition to the production of useful fuels, liquid fuel synthesis unit 500 generates byproducts such as waste water 550, heat 555 and carbon dioxide 340. Carbon dioxide 340 that is produced as a by-product of synthetic fuel generator 220 is recycled and fed back to the gasification reactor 200 of FIG. 3. In one embodiment, waste water 550 can be treated and recycled back to waste treatment unit 120. Heat 555 that is produced by the highly exothermic reaction of the conversion of clean syngas 250 by liquid fuel synthesis unit 500 can be reclaimed and reused by waste treatment unit 120. Alternatively, the treated waste water and heat 555 can be used by facility 100 to maximize reuse.

In one embodiment, the synthesis of liquid fuel by synthetic fuel generator 220 using clean syngas 250 as the input feedstock by way of Fischer Tropsch reaction requires clean syngas 250 to be suitably modified to ensure efficient conversion of the inorganic components into fuel containing carbon and hydrogen. In one embodiment, the composition of clean syngas 250 is adjusted with respect to the hydrogen and carbon ratio to improve the efficiency of conversion to synthetic liquid fuel 565 and gaseous fuel 570. In one embodiment, clean syngas 250 produced by gasification reactor 200 of FIG. 3 has a lower ratio of hydrogen to carbon monoxide (H₂:CO) than the ideal ratio of about 2. In one embodiment, different reactions can be utilized to adjust the H₂:CO ratio to improve the efficiency of the reaction including a water-gas shift reaction. The ratio of H₂:CO may also be adjusted by adding additional hydrogen using the electrolysis of water.

Electrolysis unit 510 is configured to receive water 530 and electrical energy 535. Electrolysis unit 510 outputs oxygen 540 and hydrogen 580. Hydrogen 580 from electrolysis unit 510 is coupled to liquid fuel synthesis unit 500 of synthetic fuel generator 220. Electrolysis unit 510 uses electrical energy 535 and water 520 to dissociate the water molecules into hydrogen and oxygen which are then separated. Hydrogen 580 that is produced by electrolysis unit 510 is added to clean syngas 250 for a fuel synthesis process while oxygen 540 that is produced by the dissociation reaction is used to produce high purity oxygen that can have a variety of medical, commercial and industrial applications. In one embodiment, oxygen 540 is used within facility 100 of FIG. 1. Thus, the expense of purchasing oxygen can be eliminated or reduced within facility 100. In general, liquid fuel synthesis unit 500 is configured to adjust temperature, pressure, and H₂ and CO ratio to optimize the Fisher Tropsch reaction in the conversion of clean syngas 250 to synthetic liquid fuel 565 and gaseous fuel 570. Electrical energy 525 is used in processes to adjust the temperature and pressure. In one embodiment, electrical energy 525 may be provided from an external source. In one embodiment, electrical energy is produced by using a portion of synthetic fuel 565 or gaseous fuel 570 that is output by liquid fuel synthesis unit 500 to power a generator. In one embodiment, a portion of electrical energy 525 is used to adjust the pressure to a desirable range of (20-40) bars to power one or more pressure compressors. In addition, another portion of electrical energy 525 is used to adjust the temperature to a desirable range of (200-300)° C. to power one or more heat exchangers.

Clean syngas 250 treated with respect to H₂:CO composition, pressure and temperature, is then used in the Fischer Tropsch reactor within liquid fuel synthesis unit 500 to undergo a series of chemical reactions that produce a variety of hydrocarbons which can be alkanes, alkenes, alcohols and other hydrocarbons that can be oxygenated. The alkanes that are produced by the treatment of clean syngas 250 comprise synthetic liquid fuel 565. In one embodiment, synthetic liquid fuel 565 can be a fuel such as diesel fuel or the like. Other gaseous fuels 570 may also be produced by the reaction as byproducts during the fuel synthesis process. Carbon dioxide 340 that is produced in the Fischer Tropsch reactor of liquid fuel synthesis unit 500 is separated from the other gaseous products using pressure swing adsorption. In one embodiment, the pressure swing adsorption is a cyclic adsorption process that allows continuous separation of gas streams and is performed by periodic changes in pressure and comprises several steps and cycles. Carbon dioxide 340 from the pressure swing adsorption process of liquid fuel synthesis unit 500 is then recycled and sent back to the gasification reactor 200 of FIG. 3.

It will be evident from the description of the current invention that a facility that produces waste can be coupled with a waste treatment unit 120 of FIG. 1 that includes gasification reactor 200 of FIG. 2 using plasma incineration with steam to convert the carbon dioxide emission from waste treatment unit 120 to produce syngas that is suitably treated and then used to produce synthetic liquid fuel 565 as well as gaseous fuel 570 while recycling the carbon dioxide produced to eliminate CO₂ emissions. Zero emission waste system 150 of FIG. 1 is created locally to facility 100 by recycling the CO₂ generated in the gasification and fuel synthesis processes back to gasification reactor 200. In addition, by the adjustment of the hydrogen to carbon monoxide gas ratio in clean syngas 250, the efficiency of the Fischer Tropsch reaction is improved in the production of synthetic liquid fuel 565 efficiently with also useful byproducts such as oxygen 540 from the local electrolysis of water by electrolysis unit 510 to produce the hydrogen to adjust the H₂:CO ratio.

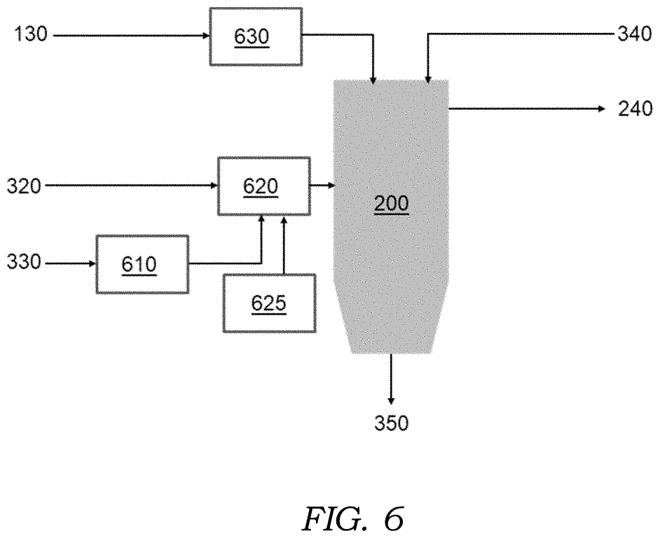

FIG. 6 is a block diagram of gasification reactor 200 of FIG. 3 in accordance with an example embodiment. Waste 130 is processed in gasification reactor 200 and converted to raw syngas 240 (synthesis gas) that is used for the synthesis of fuel. Waste 130 that is recycled is used as the feedstock for the gasification reactor 200 may be shredded into small uniform particles to make it easier to process. The feedstock is fed through a leak proof accumulator 630 before entering the main chamber of the gasification reactor 200. In one embodiment, leak proof accumulator 630 is used to maintain pressure when all valves are closed and to prevent leaks. In addition to waste 130 that is recycled, carbon dioxide 340 is coupled to gasification reactor 200. In one embodiment, carbon dioxide 340 is a by-product from liquid fuel synthesis unit 500 of FIG. 5 during the synthetic fuel conversion. Other sources of carbon dioxide from facility 100 of FIG. 1 can be provided as carbon dioxide 340 to reduce emissions. The feedstock from waste 130 and carbon dioxide 340 are the inputs to gasification reactor 200 which are treated with chemical and physical processes.

The gasification of waste 130 as feedstock along with the recycled carbon dioxide is done using a plasma arc that uses the dense super-hot plasma produced by a plasma torch 620. Waste 130 that is generated by facility 100 may be medical waste, industrial waste, municipal waste, biomass among other sources. Plasma torch 620 uses an inert gas in a chamber that contains electrodes to produce a spark due to a high current passed between the electrodes under a high voltage. The plasma arc that is formed between the electrodes causes the inert gas to ionize and form a dense plasma at high temperatures (2000-14000)° C. Electrical energy 330 is provided to a microwave generator 610 to produce the plasma in plasma torch 620. In one embodiment, the electrodes used in the plasma torch may be formed with metal such as tungsten, copper, hafnium, zirconium and other alloys. In one embodiment, the inert gas that is used in the plasma torch may be argon, nitrogen among others. The high density plasma produced by plasma torch 620 converts the feedstock into the component molecules by heating, melting and vaporization. The high density plasma and the high temperature cause a molecular dissociation of the feedstock and carbon dioxide by breaking the molecular bonds such that complex molecules are reduced into individual atoms. The carbon and hydrogen from the plasma gasification combines with the carbon and oxygen from the recycled carbon dioxide to form raw syngas 240 which is an output from gasification reactor 200. As already described earlier, raw syngas 240 is a combination of hydrogen, carbon monoxide and carbon dioxide (H₂, CO, CO₂). In order to increase the generation of hydrogen in raw syngas 240, steam 320 is added to the plasma torch to aid in the gasification process. In addition to raw syngas 240 that is produced by the gasification process, the inorganic materials are removed as slag 350 or vitrified ash. In one embodiment, slag 350 comprises metals in the feedstock as well as inorganic materials such as glass, ceramics among other materials. The metals from slag 350 may be reclaimed and recycled using various separation techniques while the inorganic materials from slag 350 may be removed and disposed of or used as construction material for various applications. In one embodiment, waste 130 is converted to useful components that do not harm the environment and can be reused in different applications within facility 100 or has value to other entities who buy the material on the open market.

In general, plasma generated in plasma torch 620 may be produced by using a conductive coil driven by an AC current oscillating in the megahertz to gigahertz frequency range. A gas within the coil uses the inductive coupling to be excited and produce a plasma. This method of using conductive coils for plasma generation suffers from a number of disadvantages for the plasma in terms of uniformity, energy conversion efficiency and heating. Another technique for generating the plasma uses a dielectric resonator 625 which relies on the polarization current in the dielectric material used for resonator 625 to produce plasma in the gas within resonator 625 with higher intensity along greater uniformity, higher energy efficiency, lower self-heating, and lower operating costs. In one embodiment, plasma torch 620 may use dielectric resonator 625 to generate the plasma with low radio frequency losses and high power levels with good uniformity. Dielectric resonator 625 may have a central axis and a radio frequency power source electrically coupled to dielectric resonator 625 to produce an alternating polarization current flow in a dielectric resonator structure about the axis to generate plasma in an adjacent gas.

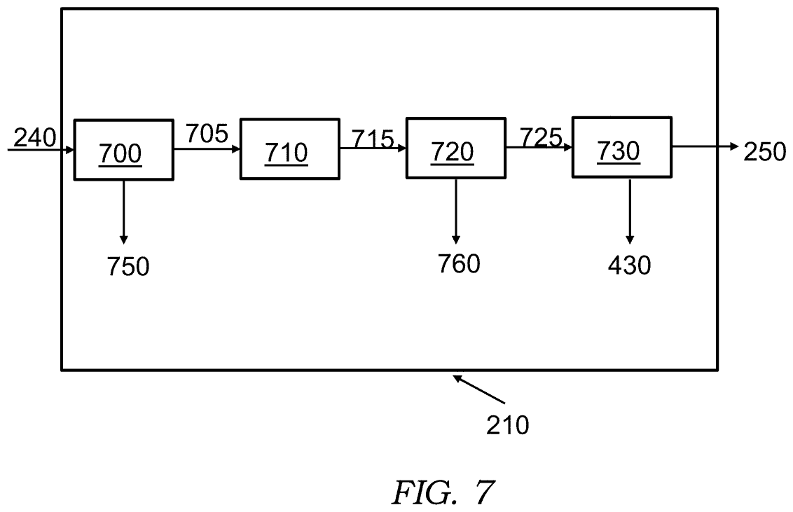

FIG. 7 is a block diagram of syngas treatment unit 210 in accordance with an example embodiment. In one embodiment syngas treatment unit 210 comprises a cyclone separator 700, a heat exchanger 710, an electrostatic precipitator 820, and a caustic scrubber 730. Raw syngas 240 produced by the gasification process is at high temperature and contains particulates and chemicals that may be detrimental to the downstream process of zero emission waste system 150 of FIG. 1. These particulates and chemicals are removed from by syngas treatment unit 210. In one embodiment, raw syngas 240 couples to and is treated in cyclone separator 700 to remove a portion of the particulates in raw syngas 240 to produce a reduced particulate density syngas 705. Cyclone separator 700 removes particulates from raw syngas 240 by using a high speed rotating air flow inside a cylindrical or conical container without the use of filters. In one embodiment, helical air flow inside cyclone separator 700 causes coarse particulates 750 to be removed by being unable to follow a tight curve of the stream, strike an outer wall of the cyclone, and fall to a bottom of cyclone separator 700 where coarse particulates 750 are removed. The design of cyclone separator 700 determines the efficiency and size of particles removed from raw syngas 740 and outputs a syngas 705 having particulates of reduced density and size. Thus, syngas 705 from cyclone separator 700 has particulates having a smaller size and density when compared to raw syngas 240.

Syngas 705 is coupled to heat exchanger 710 for further processing. Heat exchanger 710 is configured to reduce a temperature of syngas 705 to output syngas 715 having a reduced temperature. In one embodiment, cooling towers are used to remove the heat from the syngas 705. In one embodiment, the recovered heat may be used for generating low pressure steam or preheating other units in zero waste system 150. In one embodiment, further cooling may be used to reduce the temperature of syngas 715 for further processing downstream.

Syngas 715 that has been cooled is coupled to bag filter 720. Bag filter 720 treats removes and outputs fine particulates 760. Bag filter 720 outputs syngas 725 having fine particulates 760 removed. In one embodiment, fine particulates 760 are collected in a filter media of bag filter 720 by accumulating on one or more surfaces. In one embodiment, filter media of bag filter 720 may be made of various materials such as polyester, nylon, glass fiber among other materials depending on the nature of the particulates in the fluid. In one embodiment, fine particulates 760 in cooled syngas 715 are trapped in bag filter 720. Bag filter 720 outputs the cleaned and cooled syngas 725. In addition to removing the coarse and fine particulate matter from syngas, the cleaned and cooled syngas 725 can contain toxic gases 430 such as sulfur and chlorine that are removed before any downstream processing.

Syngas 725 is coupled to caustic scrubbing unit 730. Caustic scrubbing unit 730 outputs toxic gases 430. In one embodiment, toxic gases 430 comprise gases such as sulfur and chlorine as disclosed herein above. Sulfur and chlorine are removed by caustic scrubbing unit 730 by utilization of an alkaline solution such as soda ash which is used as a neutralizing agent to output clean syngas 250. In one embodiment, caustic scrubber 730 uses a multi-stage neutralization process for the removal of the sulfur and chlorine from syngas 725. Syngas treatment unit 210 outputs clean syngas 250 that is used for downstream processing. Syngas treatment unit 210 further outputs coarse particulates 750, fine particulates 750, and toxic gases 430 that can be disposed of or repurposed depending on the composition of materials.

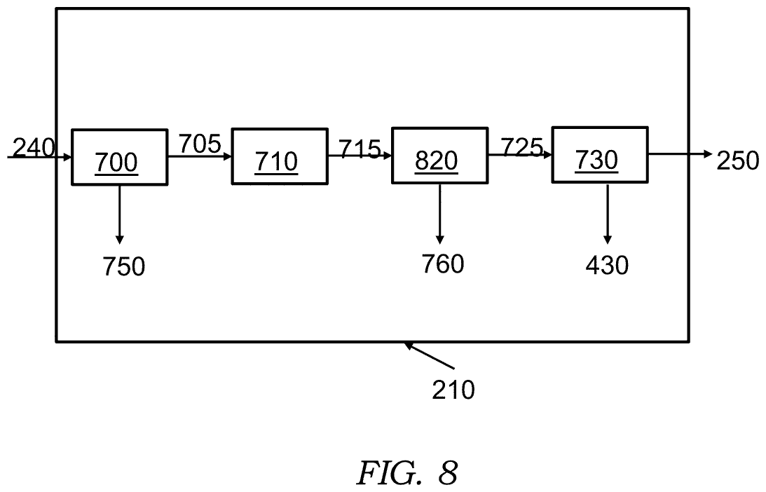

FIG. 8 is a block diagram of syngas treatment unit 210 with more details in accordance with an alternate embodiment. In one embodiment, syngas treatment unit 210 is an alternate embodiment to what is disclosed in FIG. 7 herein above. Syngas treatment unit 210 comprises cyclone separator 700, heat exchanger 710, an electrostatic precipitator 820, and caustic scrubber 730. Detailed operation of cyclone separator 700, heat exchanger 710, and caustic scrubber 730 are disclosed in FIG. 7. Raw syngas 240 is provided to syngas treatment unit 210. Raw syngas 240 with particulates and at high temperature is treated in cyclone separator 700 that removes coarse particulates 750. Cyclone separator 700 outputs syngas 705 with coarse particulates removed to heat exchanger 710. Syngas 705 is then cooled in heat exchanger 710 to produce syngas 715 having a lower temperature than syngas 705. Syngas 715 output by heat exchanger 710 is coupled to electrostatic precipitator 820. Fine particulates within syngas 715 are treated in electrostatic precipitator 820. Electrostatic precipitator 820 uses electrical energy to charge particles in syngas 715 either positively or negatively. Electrostatic precipitator 820 has collector plates that are charged to an opposite polarity of the charged particles to attract and collect the charged particle. The charged particles can then be removed from the collector plates of electrostatic precipitator 820. Thus, fine particulates 760 are electrostatically precipitated and removed from syngas 715. Electrostatic precipitator 820 outputs syngas 725 with fine particulates removed. Cleaned and cooled syngas 725 is coupled to caustic scrubber 730 to remove toxic gases 430 such as sulfur and chlorine. The removal of the acidic gases using the scrubber produces clean syngas 250 suitable for downstream processing.

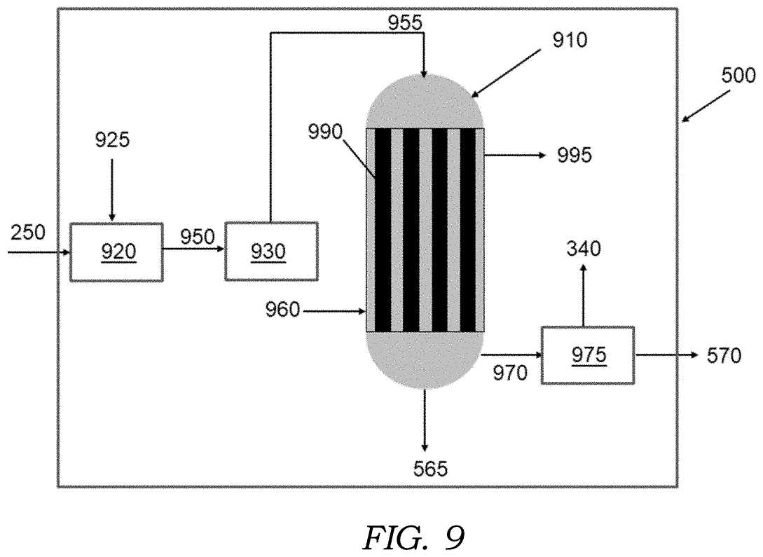

FIG. 9 is a block diagram of synthetic fuel synthesis unit 500 in accordance with an example embodiment. Synthetic fuel synthesis unit 500 corresponds to synthetic fuel synthesis unit 500 of FIG. 5 but includes additional components that will be described in more detail herein. Synthetic fuel synthesis unit 500 comprises a compressor 920, a heat exchanger 910, a multi-walled fixed bed reactor 910, and a pressure swing absorption unit 975. Clean syngas 250 from syngas treatment unit 210 is coupled to synthetic fuel synthesis unit 500. In general, clean syngas 250 that has been filtered, scrubbed and cooled is subjected to chemical reactions that produce synthetic fuels output by synthetic fuel synthesis unit 500. In one embodiment, synthetic fuel synthesis unit 500 outputs a synthetic liquid fuel 565 and gaseous fuel 570 that can be used by facility 100 of FIG. 1 or sold to external users. In addition, multi-walled fixed bed reactor 910 also produces steam 995 which can be used by facility 100 for power generation, heating, or other applications. The conversion of clean syngas 250 to synthetic liquid fuel 565 and gaseous fuel 570 also produces carbon dioxide 340 that is recycled back to gasification reactor 200 of FIG. 2 or FIG. 6 for treatment as described earlier to produce substantially zero emissions.

Clean syngas 250 that is used in a fuel synthesis process is treated to adjust the ratio of H₂ to CO to improve the efficiency of the conversion to synthetic fuel using the Fischer Tropsch reaction. The amount of hydrogen in clean syngas 250 is adjusted by the addition of hydrogen from an external source such as electrolysis unit 510 of FIG. 5. In one embodiment, liquid fuel synthesis unit 500 is configured to control the ratio of the H₂:CO increased to a value closer to the ideal ratio of 2 using hydrogen provided by electrolysis unit 510. In one embodiment, to improve the efficiency of the gas transformation reaction, clean syngas 250 is compressed using to about (20-40) bars in compressor 920. In one embodiment, electricity 925 is provided to power compressor 920. In one embodiment, electricity 925 can be provided by a green source such as solar, wind, or generated using fuel output by liquid fuel synthesis unit 500. Compressor 920 outputs a compressed syngas 950. In one embodiment, compressed syngas 950 is coupled to heat exchanger 930. Heat exchanger 930 lowers a temperature of compressed syngas 950. Heat exchanger 930 is configured to adjust a temperature of compressed syngas 950 to a desirable range such as 200-300° C. The output of heat exchanger 930 is a cooled syngas 955 coupled to multi-walled fixed bed reactor 910 as feedstock for the synthetic fuel generation process.

Multi-walled fixed bed reactor 910 is used for the processing of the syngas to convert it into useful fuels using the cascade of the Fischer Tropsch reaction. The multi-walled fixed bed reactor 910 may use different configurations for enabling the Fischer Tropsch reaction. In one embodiment, multi-walled fixed bed reactor 910 comprises a chamber with a multi-tubular fixed bed in which cooled syngas 955 flows over metallic catalysts 990 to produce a variety of hydrocarbons. Multi-tubular fixed bed reactor 910 comprises a number of small diameter tubes that include catalysts and are surrounded by cooling water that removes the heat of reaction. In one embodiment, metallic catalysts used for the Fischer Tropsch reaction comprises iron, cobalt, ruthenium among other metals including compounds such as molybdenum carbide. In addition to the metallic catalysts, promoters such as potassium and copper can also be used to enhance the reactions occurring in the reactor beds. In one embodiment, cooling water 960 supplied to multi-walled fixed bed reactor 910 removes the heat from a highly exothermic reaction. In one embodiment, the exothermic reaction causes cooling water 960 to become very hot or converted to steam 995. In one embodiment, the heated water or steam 995 may be used for energy generation, used to heat facility 100 of FIG. 1, or other purposes. Alternatively, reactor configurations such as entrained flow reactor, slurry reactor, and fluid-bed reactor may also be used for the Fischer Tropsch reaction.

The Fischer Tropsch process in the reactor bed of multi-walled fixed bed reactor 910 involves a series of reactions that converts the carbon monoxide and hydrogen in cooled syngas 955 to a variety of hydrocarbons which are primarily alkanes along with alkenes, alcohols and other oxygenated hydrocarbons. The multi-step reaction pathways involves the splitting of the carbon oxygen bond, the disassociation of the hydrogen, and formation of carbon to carbon bonds in addition to other intermediate reactions and reaction products. The process is typically operated in a temperature range of (150-300)° C. with higher temperatures favoring faster reaction and higher conversion rate but with high methane production, which is undesirable. Similarly, higher pressures ranging from one to tens of atmospheres favor higher reaction rates but with added complexity of making the reactor high pressure compatible.

In one embodiment, multi-walled fixed bed reactor 910 produces synthetic liquid fuel 965 and gaseous product 970. Liquid fuel 965 and gaseous product 970 are synthesized from cooled syngas 955 reacting with catalyst 990 with the appropriate temperature and pressure ranges as disclosed herein above. In one embodiment, most of liquid fuel 965 produced are alkanes such as diesel fuel. In addition to alkenes, alcohols and other oxygenated hydrocarbons can be products of liquid fuel 965.

Gaseous product 970 may also contain other gases that be produced by the reaction as byproducts during the fuel synthesis process. In one embodiment, carbon dioxide 340 that is produced in gaseous product 970 produced by the Fischer Tropsch reactions in the multi-walled fixed bed reactor 910 is separated from the other gaseous products using pressure swing adsorption unit 975. In one embodiment, pressure swing adsorption unit 975 uses a cyclic adsorption process that allows continuous separation of gas streams and is performed by periodic changes in pressure and comprises several steps and cycles. Carbon dioxide 340 from a pressure swing adsorption process is recycled and sent back to gasification reactor 200 of FIG. 3 to be used in the gasification of waste 130 of FIG. 1.

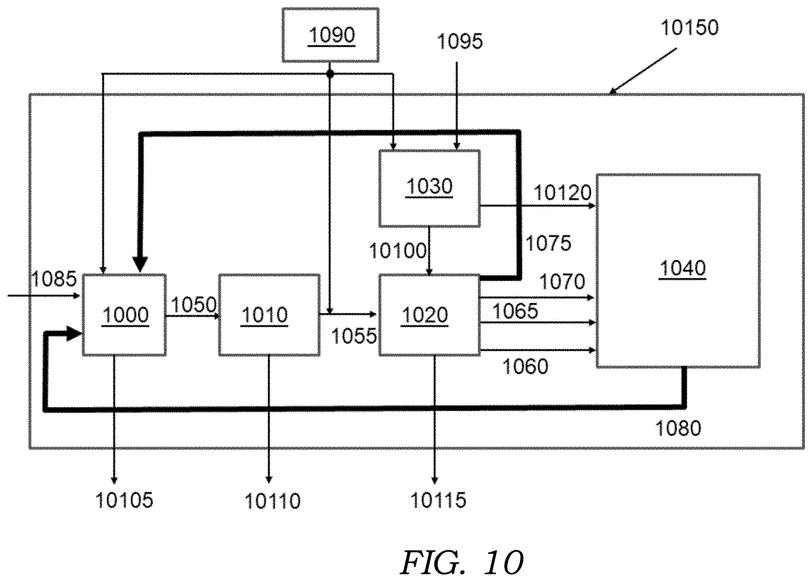

FIG. 10 is a block diagram of a zero emission waste system configured for treatment of medical waste 1080 in accordance with an example embodiment. Zero emission medical system 10150 comprises a medical facility 1040 that is coupled to a medical waste treatment facility to dispose of medical waste 1080 on-site. In one embodiment, the medical waste treatment facility is within medical facility 1040, local to medical facility 1040, or a mobile waste treatment that couples to medical facility 1040. In one embodiment, medical facility 1040 comprises 25 or more people that produce medical waste 1080 that is contaminated by blood, body fluids, or other potentially infectious materials that may be hazardous to humans as well as to the environment. Medical waste 1080 are handled different than general waste material with specific guidelines and disposal methods that are regulated. Medical facility 1040 may be a hospital, clinic, surgery center, intermediate care facility, physicians' offices, hospice, dental practices, blood banks among others. Medical waste 1080 produced by the medical facility 1040 may comprise materials such as discarded needles that may expose waste workers, janitors, housekeepers, and healthcare personnel to injuries and infections when containers or packaging break open. Used needles can transmit serious diseases such as hepatitis, human immunodeficiency virus (HIV) among other diseases and pathogens. Medical waste 1080 produced in medical facility 1080 may be cultures and stocks, bulk blood, pathological wastes, isolation wastes, animal wastes, low level radioactive waste, chemical wastes, among others. In general, all medical waste 1080 require strict protocols and training for segregation, handling, containment, labeling, storage, transport and disposal.

Medical waste 1080 produced in medical facility 1040 may be treated with incineration, thermal treatment using microwave technologies, steam sterilization, electropyrolysis, and chemical mechanical systems among others. Incineration is a method for disposing of medical waste 1080 but can generate emissions that are harmful to humans and the environment. The Environment Protection Agency (EPA) has strict guidelines for emissions for medical waste incinerators due to significant concerns over detrimental air quality which can affect human health. A self-contained facility that treats medical waste 1080 with substantially zero emissions has advantages of reducing risks to humans as well as the environment. Considering the risks in the disposal of medical waste 1080, an on-site medical waste treatment unit corresponding to waste treatment unit 120 of FIG. 1 with substantially zero emissions provides significant advantages from health, environment and safety perspectives. In addition, useful byproducts such as fuel (liquid and gaseous), oxygen, or steam are produced to improve the efficiency of zero emission waste system 10150.

The medical waste treatment unit comprises a gasification reactor 1000, a syngas treatment unit 1010, a reactor 1020, and an electrolysis unit 1030. It should be noted that operation of gasification reactor 1000, syngas treatment unit 1010, reactor 1020, and electrolysis unit 1030 respectively corresponds to gasification reactor 200 of FIG. 3, syngas treatment unit 210 of FIG. 4, liquid fuel synthesis unit 500 of FIG. 5, and electrolysis unit 510 of FIG. 5 unless specifically disclosed herein below. The medical waste treatment unit uses electrical energy 1090 for powering devices in part of which may be self-produced by zero emission medical system 10150 or it may be generated externally in a green manner such as solar or wind generated energy. Zero emission medical system 10150 inputs water 1095 and steam 1085 which from medical facility 1040, the medical waste treatment unit, or recycled from the medical waste disposal process.

Gasification reactor 1000 is configured to receive medical waste 1080 from medical facility 1040, carbon dioxide 1075 from reactor 1020, steam 1085, and electricity 1090. Carbon dioxide 1075 can also comprise carbon dioxide captured from medical facility 1040 or other sources. Medical waste 1080 are treated in a gasification reactor 1000 with steam 1085. In one embodiment, gasification reactor 1000 uses a plasma torch to produce a high density plasma that reduces medical waste 1080 to its elemental atoms. Carbon dioxide 1075 combines with the atomic carbon and steam 1085 to form raw syngas 1050 which is primarily a combination of hydrogen, carbon monoxide and carbon dioxide. The plasma torch may use a dielectric resonator to produce the high density plasma with uniform characteristics, as described earlier in FIG. 6. Gasification reactor 1000 also produces a slag 10105 that consists of vitrified ash as well as metals. Slag 10105 and metals are removed and further treated to be recycled for various purposes.

Syngas treatment unit 1010 is configured to receive raw syngas 1050 from gasification reactor 1000. Raw syngas 1050 is treated in syngas treatment unit 1010 to reduce the temperature, remove particulates by using a sequence of filters, and scrub toxic gases 10110 such as sulfur and chlorine which are detrimental to the further processing of syngas 1050. Syngas treatment unit 1010 outputs a clean syngas 1055 that is coupled to reactor 1020. Reactor 1020 also receives hydrogen from electrolysis unit 1030. Reactor 1020 processes clean syngas 1055 to produce useful fuels as well as other use byproducts such as oxygen, water, steam, and heat. Clean syngas 1055 is treated by reactor 1020 using heat exchangers to reduce a temperature of clean syngas 1055. In one embodiment, electrical energy 1090 powers one or more compressors to adjust a pressure of clean syngas 1055.

In addition, the ratio of hydrogen and carbon is also adjusted reactor 1020 by the addition of hydrogen 10100 from electrolysis unit 1030. Electrolysis unit 1030 is configured to receive water 1095 and electrical energy 1090 to dissociate water 1095 to hydrogen 10100 and oxygen 10120. Oxygen 10120 that is produced by an electrolysis process is used by medical facility 1040 as medical oxygen or for other purposes. Hydrogen 10100 that is produced by electrolysis unit 1030 is combined with clean syngas 1055 to improve the hydrogen to carbon ratio. Clean syngas 1055 combined with hydrogen 10100 is used in reactor 1020 to produce synthetic fuel using the Fischer Tropsch process described in FIG. 9. The Fischer Tropsch process produces synthesized liquid hydrocarbon fuel 1070 such as diesel, and gaseous fuel 1065 which is used in medical facility 1040 for various purposes or for external use. Reactor 1020 also outputs waste water 10115 and heat 1060. Waste water 10115 can be treated and reused by medical facility 1040 or the medical waste treatment unit. Similarly, heat 1060 generated by reactor 1020 can be used for purposes such as power generation, heating, or cleaning among other uses. Carbon dioxide 1075 that is produced by the Fischer Tropsch process of reactor 1020 is separated by pressure swing absorption and then recycled back to gasification reactor 1000, leading to a substantially zero emission medical waste treatment process.

Zero emission medical system 10150 has significant advantages in the treatment of bio-hazardous waste produced by the medical facility 1040 in terms of safety, cost, and a substantial reduction in emissions with a closed cycle operation. In addition, the production of useful synthetic fuels increases the overall efficiency of the system along with other byproducts such as medical oxygen, heat, and steam. The reclaiming of inorganic materials from the slag as well as metals improves the operational costs of the overall system.

The descriptions disclosed herein below will call out components, materials, inputs, or outputs from FIGS. 1-10. In one embodiment, a facility 100 includes an on-site waste treatment unit 120 to dispose of waste 130 with a waste treatment unit 120. Waste treatment unit comprises a gasification reactor 200, a syngas treatment unit 210, and a synthetic fuel generator 220. Synthetic fuel generator 220 comprises an electrolysis unit 510 and a liquid fuel synthesis unit 500. Gasification reactor 200 is configured to receive, waste 130, steam 320 and carbon dioxide 340. Gasification reactor 200 is configured to output slag 350 and raw syngas 240. Raw syngas 240 from gasification reactor 200 is coupled to syngas treatment unit 210. Syngas treatment unit 210 treats raw syngas 240 and outputs clean syngas 250 and toxic gases 430 such as sulfur and chlorine. Electrolysis unit 510 is configured to receive water 530 and uses electrical energy 535 to disassociate water 530 into oxygen 540 and hydrogen 580. Electrolysis unit 510 couples hydrogen 580 to liquid fuel synthesis unit 500. Oxygen 540 from electrolysis unit 510 can be used by facility 100. Liquid fuel synthesis unit 500 receives hydrogen 580 and clean syngas 250 from syngas treatment unit 210. Clean syngas 250 is combined with hydrogen 580 in liquid fuel synthesis unit 500 and uses a Fischer Tropsch process to output synthetic liquid fuel 565, gaseous fuel 570, waste water 550, heat 555 and carbon dioxide 340. Carbon dioxide 340 from liquid fuel synthesis unit 500 is coupled to gasification 200. Thus, facility 100 generates substantially zero emissions in the disposal of waste 130.

In one embodiment, facility 100 is configured to use to use two or more outputs of the waste treatment unit 120 such as oxygen 540, synthetic liquid fuel 565, gaseous fuel 570 or heat 555. Waste treatment unit 120 can be mobile and configured to couple to facility 100 to produce a combined facility with substantially zero emissions. In one embodiment, carbon dioxide 340 from the liquid fuel synthesis unit 500 is coupled to gasification reactor 200 such that carbon dioxide 340 is consumed during a process to generate raw syngas 240. In one embodiment, waste treatment unit 120 is configured to receive electrical energy from a green energy source such as solar or wind generated electrical energy. The green electrical energy can be coupled to gasification reactor 200, syngas treatment unit 210 or the synthetic fuel generator 220. Zero emission waste system 150 comprises facility 100 and waste treatment unit 120. Facility 100 can comprise at least one of a ship, a train, a facility for housing people, a hospital, a health care center, a treatment clinic, an office, a surgery center, an out-patient treatment center, a medical facility, a residential community, a retirement community, or a facility having 25 or more workers. Waste treatment unit 120 with gasification reactor 200 includes plasma torch 620. Plasma torch 620 includes a dielectric resonator structure 625 to increase the efficiency of plasma generation.

In one embodiment, facility 100 has waste treatment unit 120 local to the facility for disposing of waste 130 generated by facility 100. Waste treatment unit 100 generates substantially zero emissions in a waste disposal process. Facility 100 or waste treatment unit 120 will utilize two or more outputs from waste treatment unit 120. For example, outputs such as synthetic liquid fuel 565, gaseous fuel 570, slag 350, oxygen 540, hydrogen 580, water 530, or heat 555 among others from waste 130 are reused by facility 100 or waste treatment unit 120. Waste treatment unit 120 includes electrolysis unit 510 configured for converting water (H₂O) 530 to Oxygen (O) 540 and Hydrogen (H) 580 and wherein hydrogen 580 from electrolysis unit 510 is configured to support a conversion of clean syngas 250 to a synthetic liquid fuel 565 and gaseous fuel 570. In one embodiment, oxygen 540 from electrolysis unit 510 is coupled to facility 100 for use within or by facility 100.

In facility 100, waste treatment unit 120 comprises gasification reactor 200 configured for receiving waste 130, steam 320, and carbon dioxide (CO₂) 340. Gasification reactor 200 outputs slag 350 and raw syngas 240. Raw syngas 240 from gasification reactor 200 is coupled to syngas treatment unit 210. Gasification reactor is configured to output toxic gases 430 such as sulfur and chlorine and output clean syngas 250. In addition, waste treatment unit 120 comprises liquid fuel synthesis unit 220 configured to receive clean syngas 250 from syngas treatment unit 210. Liquid fuel synthesis unit 220 is also configured to receive hydrogen 580 from electrolysis unit 510. Liquid fuel synthesis unit 220 outputs synthetic liquid fuel 565 and gaseous fuel 570. Liquid fuel synthesis unit 220 is configured to introduce hydrogen 580 from electrolysis unit 510 to clean syngas 250. Liquid fuel synthesis unit 220 is configured to adjust the ratio of hydrogen (H₂) to carbon monoxide (CO) to improve efficiency of conversion of clean syngas 520. The temperature and pressure of clean syngas 250 is adjusted by liquid fuel synthesis unit to optimize a Fischer Tropsch reaction. In one embodiment, solar energy can be coupled to waste treatment unit 120 for providing electrical energy 330 or electrical energy 535. In one embodiment, electricity 535 coupled to facility 100 or waste treatment unit 120 is generated using synthetic liquid fuel 565 or gaseous fuel 570 from liquid fuel synthesis unit 220. Waste water 550 generated by liquid fuel synthesis unit 220 is treated by waste treatment unit 120 and returned to facility 100 or waste treatment unit 120. In one embodiment, liquid fuel synthesis unit 220 is configured to convert waste water 550 to form steam that is used to heat facility 100. In one embodiment, carbon dioxide (CO₂) 340 output by liquid fuel synthesis unit 220 is provided to gasification reactor 200 such that steam 320, carbon dioxide 340 and waste 130 are converted to raw syngas 240 and slag 350. Gasification reactor 200 includes plasma torch 620 for processing waste 130. In one embodiment, plasma torch 620 includes a dielectric resonator 625 to increase the efficiency of plasma generation.

In one embodiment, facility 100 has waste treatment facility 120 for disposing of waste 130 generated by facility 100. Waste treatment facility 120 comprises a gasification reactor 200, syngas treatment unit 210, a liquid fuel synthesis unit 500 and an electrolysis unit 510. Gasification reactor 200 is configured to receive waste 130, steam 320 and carbon dioxide (CO₂) 340. Gasification reactor 200 outputs slag 350 and raw syngas 240. In one embodiment, gasification reactor 200 includes plasma torch 620 having a dielectric resonator 625 to increase plasma generation efficiency.

Syngas treatment unit 210 is configured to receive raw syngas 240 from gasification reactor 200. Syngas treatment unit outputs toxic gases 430 and clean syngas 250. Toxic gases 430 can comprise sulfur, chlorine, and other gases. Synthetic fuel generator 200 comprises electrolysis unit 510 and liquid fuel synthesis unit 500. Electrolysis unit 510 is configured to receive water 530 and output oxygen (O) 540 and hydrogen (H) 580. Liquid fuel synthesis unit 500 is configured to receive clean syngas 250 and hydrogen 580. Liquid fuel synthesis unit 500 outputs synthetic liquid fuel 565, gaseous fuel 570, waste water 550, heat 555 and carbon dioxide (CO₂) 340. Carbon dioxide 340 is provided to gasification reactor 200. As disclosed herein, gasification reactor 200 consumes carbon dioxide 340 in generating raw syngas 240 and slag 350. Thus, waste treatment unit 120 generates substantially zero emissions. In one embodiment, facility 100 comprises at least one of a ship, a train, a facility for housing people, a hospital, a health care center, a treatment clinic, an office, a surgery center, an out-patient treatment center, a medical facility, a residential community, a retirement community, or a facility having 25 or more workers.

The descriptions disclosed herein below will call out components, materials, inputs, or outputs from FIGS. 1-10. The example herein below relates to zero emission waste system 150 that operates within a medical environment. Facility 100 is a medical facility that generates waste 130 that is medical in nature and is regulated in how medical waste 130 is disposed of. Medical zero emission waste system 150 comprises waste treatment unit 120 coupled to medical facility 100. Waste treatment unit 120 is configured for processing medical waste 130. In general, medical facility 100 generates medical waste 130 that is provided to a medical waste treatment unit 120. Medical waste treatment unit 120 is operatively coupled to medical facility 100. Medical waste treatment unit 120 is configured to process medical waste 130 on-site. At least two byproducts of medical waste treatment unit 120 are used by medical facility 100. Medical waste treatment unit 120 generates substantially zero emissions in a disposal of medical waste 130.

Synthetic fuel generator 220 comprises electrolysis unit 510 and liquid fuel synthesis unit 500. Synthetic fuel generator 220 is configured to convert clean syngas 250 to synthetic fuel and gaseous fuel. Medical waste treatment unit 120 includes an electrolysis unit 510 that is configured to receive water 530 and electrical energy 535. Electrolysis unit 510 is configured to output Hydrogen 580 and Oxygen 540. In one embodiment, oxygen 540 generated by electrolysis unit 510 is used within medical facility 100. Liquid fuel synthesis unit 500 is configured to receive Hydrogen 580 from electrolysis unit 510. Liquid fuel synthesis unit 500 also receives clean syngas 250 that is generated from medical waste 130. Liquid fuel synthesis unit 500 is configured to generate waste water 550, synthetic liquid fuel 565, gaseous fuel 570, carbon dioxide 340, and heat 555. Medical facility 100 is configured to use at least one of the waste water 550, synthetic liquid fuel 565, gaseous fuel 570, carbon dioxide 340, or heat 555 from liquid fuel synthesis unit 500.

Medical facility 100 purifies the waste water 550 from liquid fuel synthesis unit 500 for reuse. Synthetic liquid fuel 565 or gaseous fuel 570 is configured to generate electrical energy 330, 525, or 925 for powering components within medical waste treatment unit 120. Alternatively, synthetic liquid fuel 565 or gaseous fuel 570 can be used to provide electrical energy to medical facility 100. In general, synthetic liquid fuel 565 or gaseous fuel 570 would be used to power a generator for creating electrical energy. Heat 555 generated by liquid fuel synthesis unit 500 can be configured to heat medical facility 100. Carbon dioxide 340 produced by synthetic fuel generator 220 is consumed by gasification reactor 200 of medical waste treatment unit 120 such that substantially zero emissions are generated.

Liquid fuel synthesis unit 500 comprises a compressor 920, a heat exchanger 930, a fixed bed reactor 910 (multi-walled), and a pressure swing absorption unit 975. Compressor 920 is configured to receive clean syngas 250 and electrical energy 925. Heat exchanger 930 couples to compressor 920. Multi-walled fixed bed reactor 910 couples to heat exchanger 930. Multi-walled fixed bed reactor is configured to receive cooling water 960. Multi-walled fixed bed reactor 910 is configured to output steam 995, synthetic liquid fuel 565, and a gaseous fuel 570. Pressure swing absorption unit 975 is coupled to multi-walled fixed bed reactor 910. Pressure swing absorption unit 975 is configured to output carbon dioxide 350 and gaseous fuel 570. Steam 995 generated by multi-walled fixed bed reactor 910 corresponds to heat generated by liquid fuel synthesis unit 500. Steam 995 can be coupled to medical facility 100 for use such as heating.

Medical waste treatment unit 120 includes gasification reactor 200. Gasification reactor 200 is configured to receive medical waste 130 and carbon dioxide 340. In one embodiment, gasification reactor 200 receives carbon dioxide 340 from liquid fuel synthesis unit 500. Gasification reactor 200 is configured to generate raw syngas 240, slag 350, and metals from medical waste 130. Gasification reactor 200 includes a plasma torch 620. Gasification reactor 200 is configured to receive heat 555 from liquid fuel synthesis unit 500. Leak proof accumulator 630 is coupled to gasification reactor 200 for receiving medical waste 130. Plasma torch 620 includes dielectric resonator 625 to support plasma generation.

Medical waste treatment unit 120 includes syngas treatment unit 210 that couples to gasification reactor 200. Syngas treatment unit 210 is configured to receive raw syngas 240 from gasification reactor 200. Syngas treatment unit 210 is configured to clean raw syngas 240 and output clean syngas 250 to liquid fuel synthesis unit 500. Syngas treatment unit 210 comprises cyclone separator 700, heat exchanger 710, bag filter 720, and caustic scrubber 730. Cyclone separator 700 is configured to receive raw syngas 240. Heat exchanger 710 couples to cyclone separator 700. Bag filter 720 couples to heat exchanger 710. Caustic scrubber 730 couples to bag filter 720. Caustic scrubber 730 is configured to provide clean syngas 250 to liquid fuel synthesis unit 500.

Medical waste treatment unit 120 includes syngas treatment unit 210 that couples to gasification reactor 200. Syngas treatment unit 210 is configured to clean raw syngas 240 and output clean syngas 250 to liquid fuel synthesis unit 500. Syngas treatment unit 210 comprises cyclone separator 700, heat exchanger 710, electrostatic precipitator 820, and caustic scrubber 730. Cyclone separator 700 is configured to receive raw syngas 240. Heat exchanger 710 couples to cyclone separator 700. Electrostatic precipitator 820 couples to heat exchanger 710. Caustic scrubber 730 couples to electrostatic precipitator 820. Caustic scrubber 730 is configured to provide clean syngas 250 to liquid fuel synthesis unit 500.

Medical facility 100 generates medical waste 130. Medical waste treatment unit 120 is operatively coupled to medical facility 100. Medical waste treatment unit 120 comprises gasification reactor 200, syngas treatment unit 210, electrolysis unit 510, and liquid fuel synthesis unit 500. Gasification reactor 200 is configured for receiving medical waste 130, steam 320, and carbon dioxide 340. Gasification reactor 200 is configured to output slag 350 and raw syngas 240. Syngas treatment unit 210 is configured to receive raw syngas 240. Syngas treatment unit 210 is configured to output toxic gases 430 such as sulfur and chlorine. Syngas treatment unit 210 is configured to output clean syngas 250. Electrolysis unit 510 is configured to receiver water 530. Electrolysis unit 510 is configured to output Oxygen 540 (O) and Hydrogen 580 (H). Liquid fuel synthesis unit 500 is configured to receive clean syngas 250 and Hydrogen 580. Liquid fuel synthesis unit 500 is configured to output synthetic liquid fuel 565 and gaseous fuel 570. Medical facility 100 generates substantially zero emissions in a disposal of medical waste 130.

Medical facility 100 generates medical waste 130. Medical waste treatment unit 120 is operatively coupled to medical facility 100. Medical waste treatment unit 120 comprises gasification reactor 200, syngas treatment unit 210, electrolysis unit 510, and liquid fuel synthesis unit 500. Gasification reactor 200 is configured for receiving medical waste 130, steam 320, and carbon dioxide 340. Gasification reactor 200 is configured to output slag 350 and raw syngas 240. Gasification reactor 200 includes plasma torch 620 having dielectric resonator 625 to support plasma generation. Syngas treatment unit 210 is configured to receive raw syngas 240. Syngas treatment unit 210 is configured to output toxic gases 430 such as sulfur and chlorine. Syngas treatment unit 210 is configured to output clean syngas 250. Electrolysis unit 510 is configured to receiver water 530. Electrolysis unit 510 is configured to output Oxygen 540 (O) and Hydrogen 580 (H). Liquid fuel synthesis unit 500 is configured to receive clean syngas 250 and Hydrogen 580. Liquid fuel synthesis unit 500 is configured to output synthetic liquid fuel 565 and gaseous fuel 570. Medical facility 100 generates substantially zero emissions in a disposal of medical waste 130.

The present invention is applicable to a wide range of medical facilities such as but not limited to hospitals, medical clinics, medical buildings, medical research, dentist facilities, senior care facilities, laboratories, medical complexes, outpatient care, long-term patient care, hospice, emergency care, surgical centers, birth centers, blood banks, medical offices, dialysis centers, imaging centers, radiology centers, addiction treatment centers, mental health centers, rehabilitation centers, urgent care facilities, or any facilities that generate human or bio-hazardous waste. Local waste treatment unit 120 eliminates the need to handle, package, transport, sort, and dispose of medical waste 130 generated by medical facility 100. All of the energy, pollution, and costs related to moving and handling of medical waste 130 are saved. Medical waste treatment unit 120 produces two or more outputs that can be used by medical facility 100. Other outputs of medical waste treatment unit 120 can also be used or sold by entities outside of medical facility 100. In general, outputs of medical waste treatment unit 120 are put in a useful form to be used by people or used in manufacturing. Thus, medical waste 130 is converted to products that do not harm the environment using a process that has substantially zero emissions.

While the present invention has been described with reference to particular embodiments, those skilled in the art will recognize that many changes may be made thereto without departing from the spirit and scope of the present invention. Each of these embodiments and obvious variations thereof is contemplated as falling within the spirit and scope of the invention.

What is claimed is:

1. A medical facility that generates medical waste including a medical waste treatment unit operatively coupled to the medical facility wherein the medical waste treatment unit is configured to convert medical waste on-site wherein at least two byproducts of the medical waste treatment unit are used by the medical facility and wherein the medical waste treatment unit generates substantially zero emissions.

2. The medical facility of claim 1 wherein the waste treatment unit includes an electrolysis unit is configured to receive water and electrical energy and wherein the electrolysis unit is configured to output hydrogen and oxygen.

3. The medical facility of claim 1 wherein the oxygen generated from the electrolysis unit is used within the medical facility.

4. The medical facility of claim 2 wherein the waste treatment unit includes a liquid fuel synthesis unit, wherein the liquid fuel synthesis unit is configured to receive hydrogen from the electrolysis unit, wherein the liquid fuel synthesis unit is configured to receive clean syngas generated from the medical waste, and wherein the liquid fuel synthesis unit is configured to generate waste water, synthetic liquid fuel, gaseous fuel, carbon dioxide, or heat.

5. The medical facility of claim 4 wherein the medical facility is configured to use at least one of the waste water, synthetic liquid fuel, gaseous fuel, or heat generated from the liquid fuel synthesis unit.

6. The medical facility of claim 4 wherein the waste water is purified for use within the medical facility.

7. The medical facility of claim 4 wherein the synthetic liquid fuel or the gaseous fuel is configured to generate electrical energy.

8. The medical facility of claim 4 wherein the heat is generated by the liquid fuel synthesis is configured to heat the medical facility.

9. The medical facility of claim 4 wherein the carbon dioxide is configured for use by the medical waste treatment unit.

10. The medical facility of claim 4 wherein the liquid fuel synthesis unit comprises:
a compressor configured to receive clean syngas and electrical energy;
a heat exchanger coupled to the compressor;
a fixed bed reactor coupled to the heat exchanger wherein the fixed bed reactor is configured to receive cooling water, wherein the fixed bed reactor is configured to output steam, wherein the fixed bed reactor is configured to output the synthetic liquid fuel, and wherein the fixed bed reactor is configured to output a gaseous fuel and
a pressure swing absorption unit coupled to the fixed bed reactor wherein the pressure swing absorption unit is configured to output the carbon dioxide and wherein the pressure swing absorption unit is configured to output the gaseous fuel.

11. The medical facility of claim 10 wherein the steam generated by the fixed bed reactor corresponds to heat generated by the liquid fuel synthesis unit and wherein the steam is used by the medical facility.

12. The medical facility of claim 4 wherein the waste treatment unit includes a gasification reactor wherein the gasification reactor is configured to receive medical waste, wherein the gasification reactor is configured to receive the carbon dioxide from the liquid fuel synthesis unit, wherein the gasification reactor is configured to generate raw syngas, slag, and metals from the medical waste.

13. The medical facility of claim 12 wherein the gasifier reactor includes a plasma torch.

14. The medical facility of claim 12 wherein the gasification reactor is configured to receive the heat from the liquid fuel synthesis unit and wherein a leak proof accumulator is coupled to the gasification reactor for receiving the medical waste.

15. The medical facility of claim 12 wherein the plasma torch includes dielectric resonator to support plasma generation.

16. The medical facility of claim 12 wherein the waste treatment unit includes a syngas treatment unit coupled to the gasification reactor, wherein the syngas treatment unit is configured to receive the raw syngas from the gasification reactor, wherein the syngas treatment unit is configured to clean the raw syngas, and wherein the syngas treatment is configured to provide the clean syngas to the liquid fuel synthesis unit.

17. The medical facility of claim 16 wherein the syngas treatment unit comprises:
a cyclone separator configured to receive the raw syngas;
a heat exchanger coupled to the cyclone separator;
a bag filter coupled to the heat exchanger; and
a caustic scrubber coupled to the bag filter wherein the caustic scrubber is configured to provide the clean syngas to the liquid fuel synthesis unit.

18. The medical facility of claim 16 wherein the syngas treatment unit comprises:
a cyclone separator configured to receive the raw syngas;
a heat exchanger coupled to the cyclone;
an electrostatic precipitator coupled to the heat exchanger; and
a caustic scrubber coupled to the electrostatic precipitator wherein the scrubber is configured to provide the clean syngas to the liquid fuel synthesis unit.

19. A medical facility that generates medical waste including a medical waste treatment unit operatively coupled to the medical facility wherein the medical waste treatment unit comprises:
a gasification reactor configured for receiving medical waste wherein the gasification reactor is configured to receive steam and carbon dioxide and wherein the gasification reactor is configured to output slag and raw syngas;
a syngas treatment unit configured to receive the raw syngas wherein the syngas treatment unit is configured to output sulfur and chlorine and wherein the syngas treatment unit is configured to output clean syngas;
an electrolysis unit is configured to receive water wherein the electrolysis unit is configured to output oxygen and wherein the electrolysis unit is configured to output hydrogen; and
a liquid fuel synthesis unit is configured to receive the clean syngas and the hydrogen wherein the liquid fuel synthesis unit is configured to output synthetic liquid fuel, wherein the liquid fuel synthesis unit is configured to output gaseous fuel, and wherein the medical facility generates substantially zero emissions in a disposal of the medical waste.

20. A medical facility that generates medical waste including a medical waste treatment unit operatively coupled to the medical facility wherein the medical waste treatment unit comprises:
a gasification reactor configured for receiving medical waste wherein the gasification reactor unit is configured to receive steam and carbon dioxide, wherein the gasification reactor is configured to output slag and raw syngas, wherein the gasification reactor includes a plasma torch having a dielectric resonator to support plasma generation;
a syngas treatment unit configured to receive the raw syngas wherein the syngas treatment unit is configured to output sulfur and chlorine and wherein the syngas treatment unit is configured to output clean syngas;
an electrolysis unit configured to receive water wherein the electrolysis unit is configured to output oxygen and wherein the electrolysis unit is configured to output hydrogen; and
a liquid fuel synthesis unit configured to receive the clean syngas and the hydrogen wherein the liquid fuel synthesis unit is configured to output synthetic liquid fuel, wherein the liquid fuel synthesis unit is configured to output gaseous fuel, and wherein the medical facility generates substantially zero emissions in a disposal of the medical waste.
